(19) United States
(12) Patent Application Publication
(10) Pub. No.: US 2009/0200312 A1
(43) Pub. Date: Aug. 13, 2009

(54) Enhanced Vapor Recovery Ventline Screen/Enclosure

(76) Inventors: Belinda Bain, Laguna Niguel, CA (US); Jamil Hershewe, Panorama City, CA (US)

Correspondence Address: STETINA BRUNDA GARRED & BRUCKER, 75 ENTERPRISE, SUITE 250, ALISO VIEJO, CA, 92656, US

(21) Appl. No.: 12/424,275

(22) Filed: Apr. 15, 2009

Related U.S. Application Data
(60) Provisional application No. 61/138,074, filed on Dec. 16, 2008.

(51) Int. Cl. F17C 13/00

(52) U.S. Cl. 220/560.01

(57) ABSTRACT

An EVR ventline enclosure is described herein. The EVR ventline enclosure may provide a substantially sealed lower end portion to mitigate damage of the EVR System from fire or heat. The EVR ventline enclosure may encapsulate a line tapped out of the ventline routed to the EVR System. The EVR ventline enclosure may also encapsulate the canister of the EVR System. In this manner, the entire EVR System is protected from fire damage via the EVR ventline enclosure. The EVR ventline enclosure may be mounted to the ventline and not to the EVR System.

### CROSS-REFERENCE TO RELATED APPLICATIONS

This application claims the benefit of U.S. Provisional Application No. 61/138,074, filed on Dec. 16, 2008, the entire content of which is expressly incorporated herein by reference.

### STATEMENT RE: FEDERALLY SPONSORED RESEARCH/DEVELOPMENT

Not Applicable

### BACKGROUND

The present invention relates to an enclosure for an Enhanced Vapor Recovery (EVR) System.

Gasoline dispensing facilities with underground storage tanks are required to have an Enhanced Vapor Recovery (EVR) System as of Apr. 1, 2009. These EVR Systems absorb hydrocarbons from the gasoline vapors to reduce the amount of hydrocarbons emitted into the atmosphere.

The underground storage tanks at the gasoline dispensing facilities have a ventline that extends from the underground storage tanks to above ground. During different times of the day, the gasoline vapors within the underground storage tank expand and contract due to temperature changes. Upon expansion, the gasoline vapor normally vents to the atmosphere through the ventline. With the addition of the EVR System, the vapor is now absorbed into the EVR System to reduce venting of the gasoline vapors to the atmosphere. Upon contraction, the gasoline vapors absorbed into the EVR System reenters the ventline and/or the underground storage tank. The EVR System reduces the release of hydrocarbon into the atmosphere. Since hydrocarbon when combined with NOx produces ozone and particulate matter, the reduction of hydrocarbons into the atmosphere reduces the amount of ozone and particulate matter.

The EVR System is currently a state of California requirement. The addition of the EVR System has introduced other concerns which are addressed by the EVR ventline enclosure discussed herein.

### BRIEF SUMMARY

The EVR ventline enclosure discussed herein addresses the deficiencies discussed herein and those that are known in the art.

The EVR ventline enclosure may be fire rated or serve only aesthetic purposes. The fire rated version may have a sealed lower end portion. The fire rated enclosure will generally be mounted to a ventline above ground. The ventline is typically connected to an underground storage tank of a gasoline dispensing facility and the like. Fires generally originate from beneath the enclosure and not above the enclosure. As such, the sealed lower end portion of the EVR ventline enclosure protects the EVR System from fire damage (e.g., melting, excessive heat, etc.). Moreover, the fire rated enclosure may be independently mounted from the EVR System. To this end, the fire rated enclosure may be mounted to the ventline and not to the EVR System.

The enclosure may have a back panel. The back panel of the EVR enclosure may be attached to the ventline. A side panel may extend from the back panel. A cover may be rotatably attached to the side panel with a piano hinge for mitigating the entrance of heat into the enclosure. The cover may circumscribe the EVR System and be connected to the back panel. Optionally, both the cover and the side panel may have lips that extend around to the backside of the back panel to further seal the EVR enclosure and protect the EVR System from fire damage.

The bottom end portion of the enclosure may have a bottom panel comprised of a first portion and a second portion. First sections of the first and second portions may be aligned to each other via a tongue and groove connection. Additionally, a second section of the second portion may overlap a lip of the back panel. The tongue and groove connection and the overlapping connection provides protection from heat from underneath the EVR ventline enclosure.

To further provide fire protection, fire resistance putty may be disposed at gaps between panels at the lower end portion of the EVR ventline enclosure.

The upper end portion of the enclosure may have a top panel similar to the bottom end portion of the enclosure. The top panel may be comprised of a first portion and a second portion. However, unlike the bottom end portion, it is contemplated that the first and second portions of the top panel do not interconnect with each other either through a tongue and groove connection or an overlapping connection. The reason is that fires generally start from underneath the EVR ventline enclosure. Additionally, heat will rise upward. The top panel, and more particularly, one or both of the first and second portions of the top panel may be perforated to allow flow of air from within the EVR ventline enclosure to the environment.

The aesthetic version of the EVR ventline enclosure may be fabricated with a perforated cover, perforated side panel, perforated back panel, perforated bottom panel and/or perforated top panel. As such, the aesthetic version of the EVR ventline enclosure does not provide fire protection but covers the obtrusive EVR System mounted to the ventline. The EVR System is typically mounted above a rooftop of a gasoline dispending facility. As such, the EVR System and EVR ventline enclosure may be exposed to strong wind. To mitigate wind drag, and thus, forces on the ventline due to wind drag, the wind may blow through the perforated panels of the aesthetic version of the EVR ventline enclosure. This helps to mitigate or reduce forces imposed upon the ventline due to high wind conditions.

The ventline for the underground storage tanks is generally a rigid pipe. The ventline is typically mounted with U-joint brackets to a structural wall or structure of the gasoline dispensing facility. Due to the rigidity of the ventline and the strong connection between the ventline and the structural wall of the gasoline dispensing facility, the wind forces imposed on the ventline do not bend, or damage the ventline. The EVR ventline enclosure and the EVR System remain securely attached to the gasoline dispensing facility by the strong connection between the ventline and the building and the strength of the ventline itself. The same is true for both the aesthetic version of the EVR ventline enclosure and the fire rated EVR ventline enclosure.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a top perspective view of an EVR ventline enclosure mounted to a ventline of a gasoline dispensing facility;

FIG. 2 is an illustration of FIG. 1 with the EVR ventline enclosure in an open position so as to show the EVR System mounted to the ventline and the EVR ventline enclosure independently mounted to the ventline;

FIG. 3 is an enlarged view of the EVR ventline enclosure and ventline shown in FIG. 2;

FIG. 3A is a cross sectional view of a bracket for securing the EVR ventline enclosure to the ventline;

FIG. 3B is a cross sectional view of a bottom panel of the EVR ventline enclosure shown in FIG. 3;

FIG. 4 is a bottom view of the EVR ventline enclosure shown in FIG. 1;

FIG. 4A is a cross sectional view of a first portion of a bottom panel lapped onto a lip of a back panel; and

FIG. 4B is a cross sectional view of a water condensation outlet shown in FIG. 4.

### DETAILED DESCRIPTION

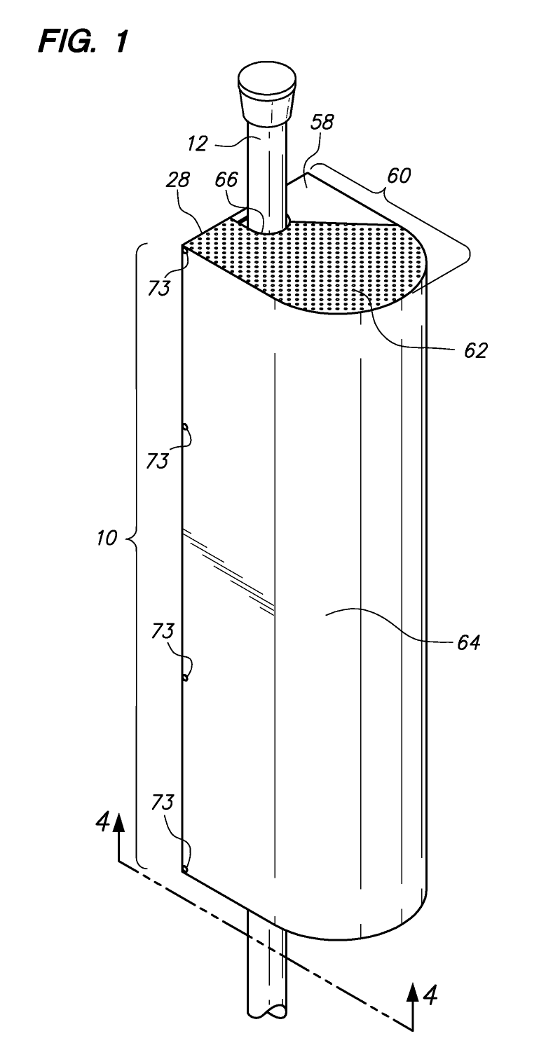

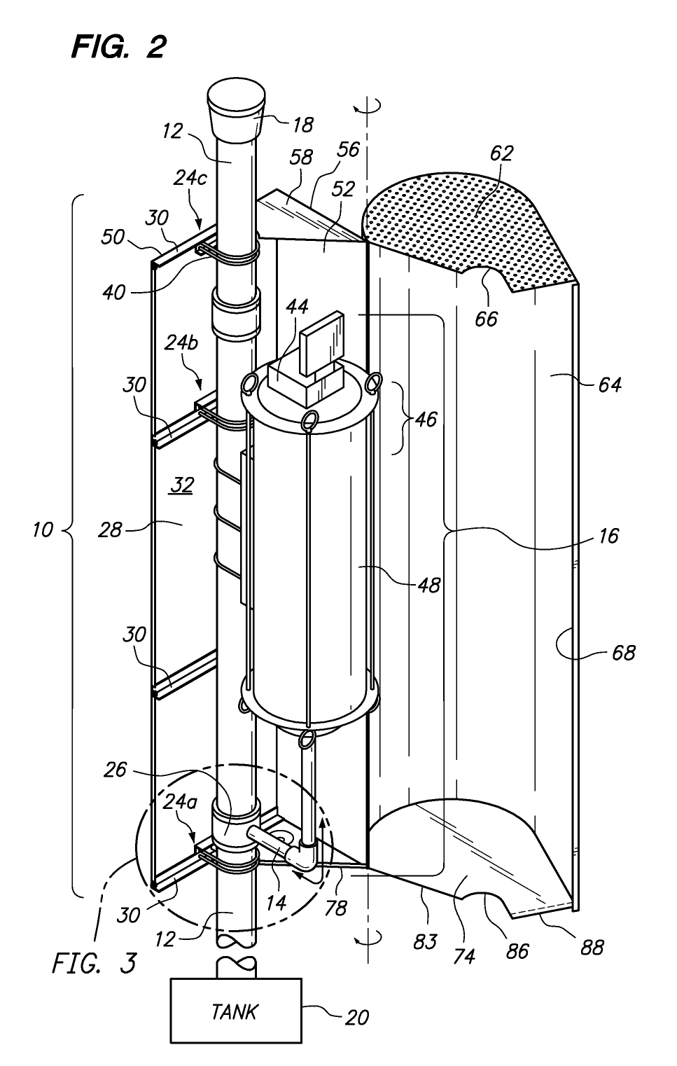

FIG. 1 is a perspective view of a fire rated EVR ventline enclosure 10 for an EVR System 16 (see FIG. 2). The fire rated EVR ventline enclosure 10 protects the EVR System 16 from heat due to fire beneath the EVR System 16. The fire rated version of the EVR ventline enclosure 10 protects the EVR System 16 from heat because the lower end portion of the EVR ventline enclosure 10 is generally sealed. As will be further discussed below, the EVR ventline enclosure 10 may also be fabricated as an aesthetic version. In the aesthetic version of the EVR ventline enclosure 10, the same does not protect the EVR System 16 from fire. Rather, the aesthetic version of the EVR ventline enclosure 10 is generally perforated to allow wind to pass through the EVR ventline enclosure 10, minimize wind drag and hide the EVR System 16 from public view.

Referring now to FIG. 2, the EVR System 16 may be mounted to a ventline 12. In use, a line 14 is tapped out of the ventline 12 from a coupling 26 and routed to a bottom of the EVR System 16. When gas vapors expand, these gas vapors are routed through line 14 and absorbed by the EVR System 16 first before venting to the atmosphere through the exhaust 18 attached to the top of the ventline 12. When the gaseous vapors contract, the gaseous vapors absorbed into the EVR System 16 are allowed to flow back into the tank 20 down below. One type of EVR System is manufactured by Veeder-Root. Although the discussion of the EVR fire rated enclosure 10 is discussed in relation to the Veeder-Root System, the EVR fire rated enclosure 10 may be mounted to other EVR Systems known in the art or developed in the future since the EVR fire rated enclosure 10 is mounted to the ventline 12 and not dependent upon the EVR System 16.

The ventline 12 is secured to a supporting structure (e.g., building, building wall, roof, etc.) through the use of two or more bracketing systems. The bracketing systems may be one or more U-joints disposed about the ventline 12 and secured to the supporting structure. This provides stability to the ventline 12. The ventline 12 may be fabricated from steel and have sufficiently thick walls to prevent bending despite high winds. Both the rigidity of the ventline 12 and the secure attachment of the ventline 12 to the supporting structure prevent any movement of the ventline 12 even though the EVR System 16, the EVR fire rated enclosure 10 and/or ventline 12 are subjected to high winds.

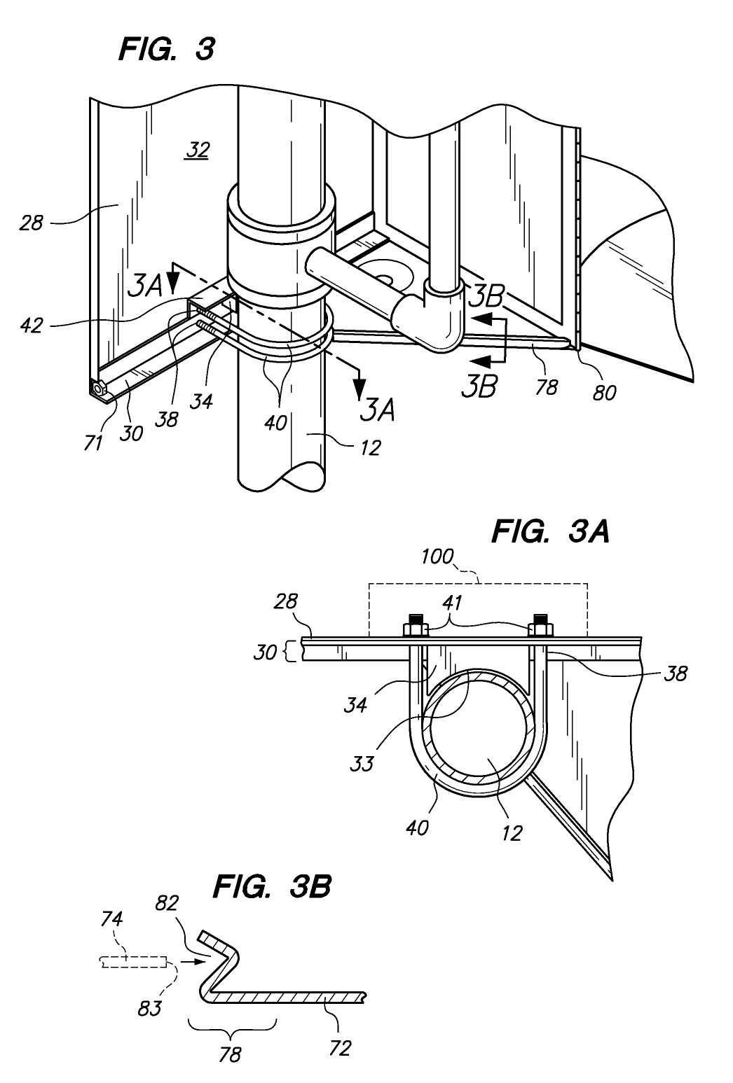

The fire rated EVR ventline enclosure 10 may have a back panel 28. The back panel 28 may be fabricated from a sixteen (16) gauge steel sheet. A plurality of L-shaped bars 30 may be vertically gapped away from each other and placed in a horizontal orientation against an inner surface 32 of the back panel 28. The L-shaped bars 30 support the back panel 28 to prevent bending. On or adjacent the L-shaped bars 30, spacers 34 (see FIGS. 3 and 3A) may be attached to the L-shaped bars 30 or the inner surface 32 of the back panel 28. As shown in FIG. 3A, a front surface 33 of the spacers 34 may have an arc configuration to mate with the round exterior surface of the ventline 12. Mounting holes 38 (see FIGS. 3 and 3A) may be drilled through the L-shaped bars 30. These mounting holes 38 are positioned to allow a U-joint 40 to be wrapped around the ventline 12 and inserted through the mounting holes 38. Nuts 41 may be tightened onto the U-joint 40 behind the back panel 28. When the nuts 41 are tightened on the U-joint 40, the ventline 12 is secured between the spacer 34 and the U-joint 40, as shown in FIG. 3A. Although two U-joints 40 may be associated with each L-shaped bar 30, as shown in FIGS. 2 and 3, it is contemplated that one U-joint 40 may be associated with each of the L-shaped bars 30. As shown in FIG. 3, an extension 42 (such as another L-shaped bar) may be attached to the inner surface 32 of the back panel 28 or may be attached to the L-shaped bar 30. The mounting holes 38 for the second U-joint 40 may be formed through the extension 42, as shown in FIG. 3.

Referring back to FIG. 2, the spacer 34 and the U-joints discussed above comprise a first mounting bracket 24a. The first mounting bracket 24a may be attached below the coupling 26 of the EVR System 16. The coupling 26 is typically where the line 14 connects the ventline 12 to the EVR System 16. The first mounting bracket 24a is typically attached below this coupling 26 such that the EVR ventline enclosure 10 encloses all parts of the EVR System 16 to protect the EVR System 16 and the line 14 from fire damage.

The second mounting bracket 24b may be disposed generally below an electronic system 44 of the EVR System 16 and generally adjacent an upper portion 46 of a canister 48 of the EVR System 16. The mounting bracket 24b may have one or two U-joints 40 that attach the back panel 28 and the L-shaped bar 30 to the ventline 12 at the specified location. The purpose of locating the second mounting bracket 24b below the electronic system 44 is to prevent interference with the electronic system 44 of the EVR System 16. An optional third mounting bracket 24c (see FIG. 2) may be attached above the electronic system 44 of the EVR System 16. In particular, an L-shaped bar 30 may be disposed at the upper end 50 of the back panel 28. One or more U-joints 40 may be used to attach the back panel 28 to the ventline 12.

The fire rated EVR ventline enclosure 10 may additionally comprise a side panel 52 (see FIG. 2) that may be coextensive in height with the back panel 28. An upper edge 56 of the side panel 52 may be attached to a first portion 58 of a top panel 60 (see FIG. 1). Referring now to FIG. 1, a second portion 62 (see FIG. 2) of the top panel 60 may butt up with the first portion 58 to prevent leaves and animals (e.g., birds, etc.) from entering the EVR fire rated enclosure 10 from above. The second portion 62 may also have a cutout 66 (see FIGS. 1 and 2) that fit around the ventline 12 when the cover 64 is in the closed position (see FIG. 1). The top panel 60 may be located at least eighteen (18) inches above the top lip of the canister 48.

The EVR fire rated enclosure 10 may additionally include a cover 64 that can be rotated between an open position (see FIG. 2) and a closed position (see FIG. 1). In the open position, the cover 64 is moved out of the way such that technicians can service the EVR Systems 16 from the side and front, as shown in FIG. 2. The EVR fire rated enclosure 10 minimally or negligibly interferes with the technician's ability to service the EVR System 16.

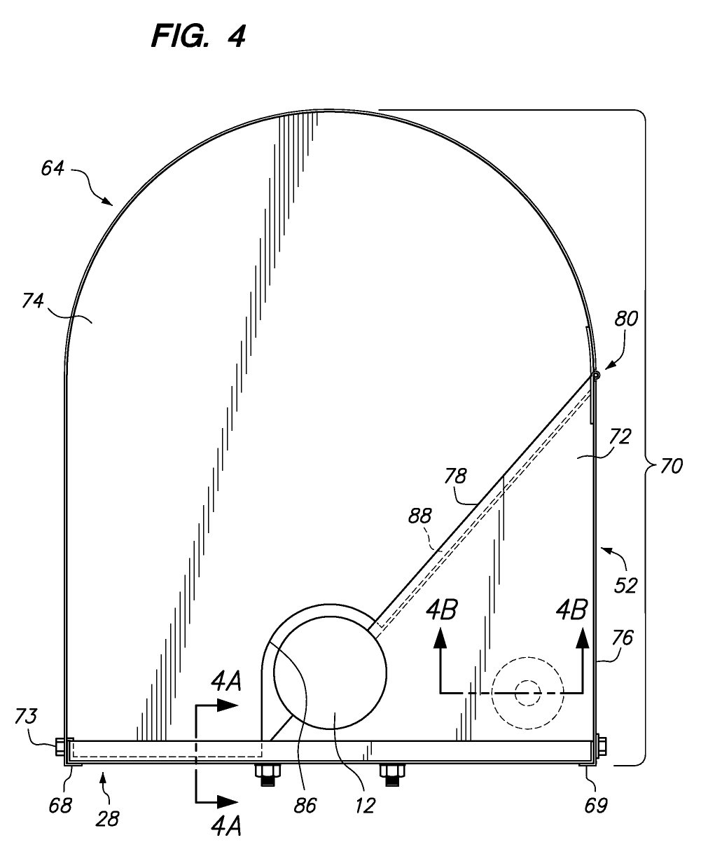

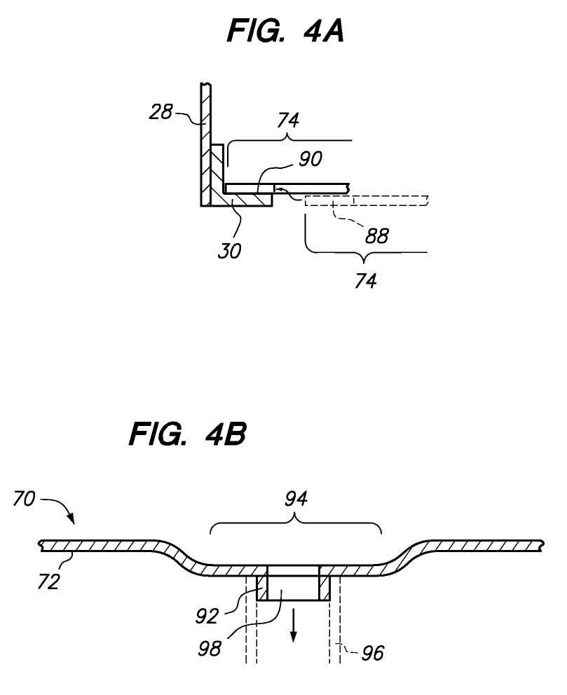

As shown in FIG. 3, a nut 71 may be welded or attached to the L-shaped bar 30. When the cover 64 is traversed to the closed position(see FIG. 1), a bolt 73, may be tightened onto the nut 71 to secure the cover 64 to the back panel 28. FIG. 1 illustrates four bolts 73 to secure the cover 64 to the back panel 28. Moreover, when the cover 64 is in the closed position, an optional lip 68 (see FIGS. 2 and 4) may be disposed behind the back panel 28 (see FIG. 4) to cover any gap between the back panel 28 and the cover 64. Similarly, the side panel 52 during assembly may be attached to the back panel 28 with a nut and bolt connection in a similar manner as the cover 64 is attached to the back panel 28. As shown in FIG. 4, an optional lip 69 may extend to the backside of the back panel 28 and cover any gap that may exist or develop between the side panel 52 and the back panel 28. The lips 68, 69 mitigate heat from entering the EVR fire rated enclosure 10 and melting or compromising the EVR System 16.

FIG. 4 illustrates a bottom panel 70 that is comprised of a first portion 72 and a second portion 74. The first portion 72 may be solely attached to the bottom edge 76 of the side panel 52. Preferably, the first portion 72 extends co-extensively with a width of the side panel 52. The first portion 72 may also have an edge 78 (see also FIG. 3) that extends from a joint 80 to the ventline 12. The edge 78 of the first portion 72 may have a recess 82 as shown in FIG. 3B. The recess 82 is directed outwardly (see FIG. 2) and engages an edge 83 of the second portion 74 of the bottom panel 70, as shown in FIG. 3B. When the cover 64 is traversed to the closed position, the edge 83 may be received into the recess 82. This provides a seal between the first and second portions 72, 74 of the bottom panel 70. The second portion 74 may additionally have a cutout 86 (see FIGS. 2 and 4) sized and configured to closely mate with the ventline 12. The second portion 74 of the bottom panel 70 may also have a lip 88 (see FIGS. 2, 4 and 4A). The lip 88 of the second portion 74 may rest on top of an upper surface 90 (see FIG. 4A) of the L-shaped bar 30 when the cover 64 is in the closed position. The overlapping connection and the tongue and groove connection provides for a substantial seal about the lower end portion of the EVR ventline enclosure 10 to mitigate fire damage. As such, the EVR fire rated enclosure 10 provides a substantially sealed lower end portion to mitigate fire damage to the EVR System 16.

To further mitigate fire damage, fire/heat resistant putty may be lined within the recess 82 (see FIG. 3B), disposed about the ventline 12 at the cutout 86 (see FIG. 4), disposed between the lip 88 and the L-shaped bar 30 (see FIG. 4A), the first portion 72 and the ventline 12 to seal any gaps at the lower end portion of the EVR ventline enclosure 10.

Moreover, due to the weight distribution, when the cover 64 is traversed to the closed position, the lip 88 of the second portion 74 is pressed down upon the L-shaped bar 30. Also, when the bottom portion of the EVR fire rated enclosure 10 is subjected to fire, warpage of the EVR fire rated enclosure 10 may cause the lip 88 to further press down on the L-shaped bar 30 and to create a better seal about all components.

Referring now to FIG. 4B, a condensation outlet 92 is shown. The condensation outlet 92 may be formed in the first portion 72 of the bottom panel 70 closely adjacent the side panel 52. The condensation outlet 92 provides an outlet for water condensation that might form within the EVR ventline enclosure 10. As you will note in FIG. 4B, the condensation outlet 92 additionally has a dimpled region 94. The dimpled region 94 gathers the water condensate to direct the water condensate through the condensation outlet 92. The condensation outlet 92 may be attached to a hose 96 that routes the water condensate to a convenient disposal area. The condensation outlet 92 has a hole 98 which is large enough to drain water condensate within the EVR ventline enclosure 10 but yet small enough to not significantly affect the fire rating of the EVR fire rated enclosure 10.

In an alternative embodiment, the EVR ventline enclosure 10 may be manufactured so as to be an aesthetic covering over the EVR System 16. To this end, one or more of the back panel 28, side panel 52, cover 64, bottom panel 70 and the top panel 60 may be perforated. In this manner, the EVR ventline enclosure 10 is not fire rated since heat flows through the perforations into the EVR ventline enclosure 10. Fortunately, the perforated or aesthetic version of the EVR ventline enclosure 10 also allows air to more readily flow through the EVR ventline enclosure 10. As such, when the EVR ventline enclosure 10 is subjected to high winds, the EVR ventline enclosure 10 has less wind drag and imposes less shearing force on the ventline 12 which holds the EVR System 16 to the structure of the gasoline dispensing facility.

In an aspect of the EVR ventline enclosure 10, optionally, a counter balance weight 100 (see FIG. 3A) may be attached to the back panel 28. As shown in FIG. 2, the EVR System 16 is mounted to the ventline 12 on one side. As such, the EVR System 16 shifts the center of gravity of the ventline 12 and EVR System 16 off center from a central axis of the ventline 12. By mounting the EVR ventline enclosure 10 to the ventline 12, the EVR ventline enclosure 10 further shifts the center of gravity off center from the longitudinal or central axis of the ventline 12. Optionally, the EVR ventline enclosure 10 may be made neutral by adding counterbalance weights 100 (see FIG. 3A) to the backside of the back panel 28 such that the center of gravity of the EVR ventline enclosure 10 is aligned to the central axis of the ventline 12. As such, the addition of the EVR ventline enclosure 10 is neutral and does not affect the weight distribution when the EVR ventline enclosure 10 is mounted to the ventline 12.

The above description is given by way of example, and not limitation. Given the above disclosure, one skilled in the art could devise variations that are within the scope and spirit of the invention disclosed herein, including various ways of securing the EVR ventline enclosure 10 to the ventline 12. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A fire rated enclosure for a vapor recovery system mounted to a ventline, the enclosure comprising:
a back panel having a lower lip defining an upper surface;
a mounting bracket attached to the back panel for mounting the enclosure to the ventline of the vapor recovery system;
a cover panel rotateable about the back panel and traverseable between an open position and a closed position; and
a bottom panel having a first portion disposed adjacent the back panel and a second portion attached to the cover panel, the first and second portions connected to each other with a tongue and groove connection and the second portion of the bottom panel lapped on top of the lip of the back panel for providing a seal at a lower end portion of the fire rated enclosure.

2. The enclosure of claim 1 further comprising:
a side panel attached to the back panel;
a piano hinge attached to the side panel and the cover panel to allow traversal of the cover panel between the closed position and the open position.

3. The enclosure of claim 1 wherein the groove has a z shaped configuration formed in the first portion of the bottom panel.

4. The enclosure of claim 1 further comprising fire resistant putty disposed within the groove.

5. The enclosure of claim 1 further comprising fire resistant putty disposed between the second portion of the bottom panel and the lip of the back panel.

6. The enclosure of claim 1 further comprising a top panel disposed at top portions of the cover panel and the back panel.

7. The enclosure of claim 1 wherein the cover panel further has a lip along a vertical edge of the cover panel for sealing the cover panel to the back panel when the cover panel is traversed to the closed position.

8. The enclosure of claim 1:
wherein the back panel defines opposed first and second sides, the cover panel is hinged to a first side of the back panel, the lower lip of the back panel is disposed closer to the second side of the back panel than the first side of the back panel such that the weight of the cover panel pushes the second portion of the bottom panel down on top of the lip of the back panel when the cover panel is traversed to the closed position;
wherein the tongue and groove connection is disposed closer to the first side of the back panel than the second side of the back panel.

9. The enclosure of claim 8 further comprising fire resistant material disposed between the lower lip of the back panel and the second portion of the bottom panel, and fire resistant material is disposed within the groove.

10. A fire rated enclosure for a vapor recovery system mounted to a ventline, the enclosure comprising:
a first panel defining a first side and an opposed second side, the first panel attached to the ventline;
a hinge attached to the first side of the first panel, the hinge extending along a substantial length of a vertical edge of the first side of the first panel;
a second panel defining a first side and an opposed second side, the first side of the second panel attached to the hinge so that the second panel is rotatable about the hinge between closed and open positions, the second side of the second panel being removeably attachable to the second side of the first panel, the first and second panels being sized and configured to enclose the vapor recovery system when the second panel is in the closed position, the vapor recovery system being accessible for servicing when the second panel is in the open position;
wherein the first and second panels form a sealed bottom panel for mitigating fire damage to the enclosed vapor recovery system and a perforated top panel.

11. The fire rated enclosure of claim 10 wherein the bottom panel formed by the first and second panels is comprised of first and second portions, the first and second portions being connected to each other with a tongue and groove connection.

12. The fire rated enclosure of claim 10 wherein the first panel is directly attached to the ventline.

13. A method of fire proof sealing a bottom end portion of a fire rated enclosure for a vapor recovery system, the method comprising the steps of:
traversing a cover panel toward a back panel;
inserting a second portion of a bottom panel attached to the cover panel into a groove formed on an edge portion of a first portion of the bottom panel attached to the back panel for sealing a bottom end portion of the fire rated enclosure; and
lapping the second portion of the bottom panel on top of an upper surface of a lip of the back panel for sealing the bottom end portion of the fire rated enclosure.

14. The method of claim 13 further comprising the steps of:
disposing fire resistant material between the lip of the back panel and the second portion of the bottom panel; and
disposing fire resistant material within the groove.
